(19) United States
(12) Patent Application Publication
(10) Pub. No.: US 2025/0223000 A1
(43) Pub. Date: Jul. 10, 2025

(54) DROPPER SEATPOST CAPABLE OF ADJUSTING MAXIMUM UPWARD STROKE

(71) Applicant: J.D COMPONENTS CO., LTD., CHANG HUA HSIEN (TW)

(72) Inventor: Yu-An LIN, CHANG HUA HSIEN (TW)

(21) Appl. No.: 19/011,103

(22) Filed: Jan. 6, 2025

(30) Foreign Application Priority Data
Jan. 9, 2024 (TW) 113100948

(51) Int. Cl. B62J 1/02

(52) U.S. Cl. CPC B62J 1/02

(57) ABSTRACT

A dropper seatpost includes an outer tube, an inner tube disposed movably in the outer tube, and a pneumatic and hydraulic cylinder disposed between the inner and outer tubes and having an upper oil chamber, a lower oil chamber, and an air chamber. When the pneumatic and hydraulic cylinder is opened, the upper and lower oil chambers communicate with each other. When the pneumatic and hydraulic cylinder is closed, the upper and lower oil chambers do not communicate with each other. A floating piston is disposed between the air chamber and the lower oil chamber. When an oil is extracted from or injected into the upper oil chamber, or the oil is extracted from or injected into the lower oil chamber, the floating piston is moved toward or away from the bottom end of the pneumatic and hydraulic cylinder, thereby adjusting a maximum upward stroke of the inner tube.

### BACKGROUND OF THE INVENTION

### 1. Field of the Invention

The present invention relates to dropper seatposts and more particularly, to a dropper seatpost that is capable of adjusting its maximum upward stroke.

### 2. Description of the Related Art

The height of a bicycle saddle significantly impacts the comfort and safety of the rider. Therefore, modern bicycles are often equipped with an adjustable seatpost, allowing the saddle height to be modified based on the rider's body size, riding habits, and environment. This adjustment ensures that the rider maintains the correct posture, improving both comfort and safety during the ride.

However, while the adjustable seatpost can lower the inner tube height to save storage space, it creates a potential inconvenience. After lowering the height of the inner tube, the rider must spend time readjusting the saddle to the appropriate height the next time the bike is used. This process causes inconvenience and frustration for the rider.

### SUMMARY OF THE INVENTION

It is one objective of the present invention to provide a dropper seatpost, which can adjust its maximum upward stroke according to actual needs.

To attain the above objective, the dropper seatpost of the present invention comprises an outer tube, an inner tube, a pneumatic and hydraulic cylinder, and a stroke adjustment assembly. The inner tube is disposed movably upward and downward in the outer tube, and the inner tube has a top end located outside the outer tube and a bottom end located inside the outer tube. The pneumatic and hydraulic cylinder is disposed in the inner and outer tubes for controlling a vertical movement of the inner tube relative to the outer tube. The pneumatic and hydraulic cylinder has at least one cylinder body provided with an upper oil chamber, a lower oil chamber, and an air chamber, a top cover mounted to a top end of the cylinder body, a bottom cover mounted to a bottom end of the cylinder body, and a control valve disposed in the cylinder body to separate the upper oil chamber and the lower oil chamber and operatable between an open position where the upper and lower oil chambers communicate with each other, so that the inner tube is allowed to be moved relative to the outer tube, and a close position where the upper and lower oil chambers do not communicate with each other, so that the inner tube is unable to be moved relative to the outer tube. The stroke adjustment assembly includes a floating piston movably disposed between the air chamber and the lower oil chamber.

It can be seen from the above that when adjusting the maximum upward stroke of the inner tube, first open the control valve and press down the inner tube to exceed its adjustable stroke, then extract an oil from the upper oil chamber or the lower oil chamber or inject the oil into the upper oil chamber or the lower oil chamber, causing the floating piston to move closer to or farther from the bottom cover based on the change in the oil volume. Next, close the control valve and release the inner tube. During the upward movement of the inner tube, the inner tube is positioned until the floating piston rests against the bottom cover, thus completing adjustment of the maximum upward stroke of the inner tube.

Preferably, the pneumatic and hydraulic cylinder includes an inner cylinder body and an outer cylinder body. The upper oil chamber is provided in the inner cylinder. The top cover is mounted to the top ends of the inner and outer cylinder bodies and forms the air chamber with the inner and outer cylinder bodies. The bottom cover is mounted to the bottom ends of the inner and outer cylinder bodies and forms the lower oil chamber with the inner and outer cylinder bodies.

Preferably, the pneumatic and hydraulic cylinder includes one said cylinder body. In this case, the upper oil chamber is formed between the top cover and the control valve, and the lower oil chamber is formed between the control valve and the floating piston, and the air chamber is formed between the floating piston and the bottom cover.

Preferably, the top end of the inner tube has a first oil chamber, a second oil chamber communicating with the first oil chamber and the upper oil chamber, and an adjustment threaded hole communicating with the first oil chamber. The stroke adjustment assembly further includes a knob screwed to the adjustment threaded hole for pushing the oil in the first oil chamber to the second oil chamber or allowing the oil in the second oil chamber to flow back into the first oil chamber. In this way, when adjusting the maximum upward stroke of the inner tube, first open the control valve and press down the inner tube to exceed its adjustable stroke, then rotate the knob to release the space in the first oil chamber, allowing the oil in the second oil chamber to flow back into the first oil chamber. At this point, the oil in the lower oil chamber flows through the control valve into the upper oil chamber and then flows from the upper oil chamber to the second oil chamber. This causes the floating piston to move closer to or farther from the bottom cover based on the change in the oil volume.

Preferably, the top end of the inner tube has a first oil chamber, a second oil chamber communicating with the first oil chamber, and an adjustment threaded hole communicating with the first oil chamber. An oil guide channel is formed between the outer surface of the pneumatic and hydraulic cylinder and the inner surface of the inner tube. The top cover has an upper guide hole communicating the second oil chamber and the oil guide channel. The pneumatic and hydraulic cylinder has a lower guide hole communicating the lower oil chamber and the oil guide channel. The stroke adjustment assembly further includes a knob screwed to the adjustment threaded hole for pushing the oil in the first oil chamber to the second oil chamber or allowing the oil in the second oil chamber to flow back into the first oil chamber. In this way, when adjusting the maximum upward stroke of the inner tube, first open the control valve and press down the inner tube to exceed its adjustable stroke, then rotate the knob to release the space in the first oil chamber, allowing the oil in the second oil chamber to flow back into the first oil chamber. At this point, the oil in the lower oil chamber flows into the second oil chamber through the lower guide hole, the oil guide channel, and the upper guide hole. This causes the floating piston to move closer to or farther from the bottom cover based on the change in the oil volume.

Preferably, the top end of the inner tube has a first oil chamber, a second oil chamber communicating with the first oil chamber, and a button hole communicating with the second oil chamber and the upper oil chamber. The stroke adjustment assembly further includes a piston movably disposed in the first oil chamber for pushing the oil in the first oil chamber into the second oil chamber or allowing the oil in the second oil chamber to flow back into the first oil chamber, a button movably disposed in the button hole and movable between an initial position where the second oil chamber and the upper oil chamber do not communicate with each other by obstruction of the button and a pressed position where the second oil chamber and the upper oil chamber communicate with each other through a communication hole of the button, and a return elastic member acting on the button to keep the button in the initial position. In this way, when adjusting the maximum upward stroke of the inner tube, first open the control valve and press down the inner tube to exceed its adjustable stroke, then press the button to the pressed position. At this point, the oil in the lower oil chamber flows through the control valve into the upper oil chamber. This causes the floating piston to move closer to or farther from the bottom cover based on the change in the oil volume.

Preferably, an oil guide channel is formed between the outer surface of the pneumatic and hydraulic cylinder and the inner surface of the inner tube, and an oil storage space communicating with the oil guide channel is formed between the bottom end of the pneumatic and hydraulic cylinder and the bottom end of the inner tube. The top cover has an upper guide hole communicating with the oil guide channel and a plunger hole communicating with the upper guide hole and the upper oil chamber. The stroke adjustment assembly further includes a plunger disposed in the plunger hole and operable between a close position where the upper oil chamber and the upper guide hole do not communicate with each other and an open position where the upper oil chamber and the upper guide hole communicate with each other. In this way, when adjusting the maximum upward stroke of the inner tube, first open the control valve and the plunger and press down the inner tube to exceed its adjustable stroke. At this point, the oil in the lower oil chamber is allowed to flow into the oil storage space through the upper oil chamber, the upper guide hole, and the oil guide channel; alternatively, the oil in the oil storage space is allowed to flow into the lower oil chamber through the oil guide channel, the upper guide hole, and the upper oil chamber. This causes the floating piston to move closer to or farther from the bottom cover based on the change in the oil volume.

Preferably, the bottom end of the inner tube is equipped with an end cover. The stroke adjustment assembly further includes an adjustment piston movably disposed between the bottom cover and the end cover. The oil storage space is formed between the adjustment piston and the bottom cover, and an air chamber is formed between the adjustment piston and the end cover. In this way, when the adjustment piston is moved toward the bottom cover according to the change in the oil volume, the air in the air chamber is pushed by the adjustment piston and then expelled to the outside.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a dropper seatpost of a first embodiment of the present invention.

FIG. 2 is a sectional view of the dropper seatpost of the first embodiment of the present invention.

FIG. 3 is an enlarged view of FIG. 2, showing the top end of the inner tube.

FIG. 4 is a sectional view taken along line 4-4 of FIG. 3.

FIG. 5 is similar to FIG. 2, showing that the control valve is opened and the inner tube is pressed.

FIG. 6 is similar to FIG. 4, showing that the knob is rotated outward.

FIG. 7 is a sectional view of the dropper seatpost of the first embodiment of the present invention, showing that the floating piston is moved toward the bottom cover.

FIG. 8 is similar to FIG. 2, showing that the maximum upward stroke of the inner tube is reduced.

FIG. 9 is a sectional view of the dropper seatpost of a second embodiment of the present invention.

FIG. 10 is similar to FIG. 9, showing that the control valve is opened and the inner tube is pressed.

FIG. 11 is a sectional view of the dropper seatpost of the second embodiment of the present invention, showing that the floating piston is moved toward the bottom cover.

FIG. 12 is similar to FIG. 9, showing that the maximum upward stroke of the inner tube is reduced.

FIG. 13 is a sectional view of the dropper seatpost of a third embodiment of the present invention.

FIG. 14 is an enlarged view of FIG. 13, showing that the button is located at the initial position.

FIG. 15 is similar to FIG. 14, showing that the button is located at the pressed position.

FIG. 16 is similar to FIG. 13, showing that the control valve is opened and the inner tube is pressed.

FIG. 17 is similar to FIG. 13, showing that the maximum upward stroke of the inner tube is reduced.

FIG. 18 is a sectional view of the dropper seatpost of a fourth embodiment of the present invention.

FIG. 19 is similar to FIG. 18, showing that the control valve and the plunger are opened, and the inner tube is pressed.

FIG. 20 is an enlarged view of FIG. 19, showing the plunger is located at the open position.

FIG. 21 is an enlarged view of FIG. 19, showing the control valve is located at the open position.

FIG. 22 is similar to FIG. 18, showing that the maximum upward stroke of the inner tube is reduced.

FIG. 23 is a sectional view of the pneumatic and hydraulic cylinder provided by the dropper seatpost of a fifth embodiment of the present invention, showing that the valve stem is located at the close position.

FIG. 24 is a sectional view of the dropper seatpost of a sixth embodiment of the present invention.

FIG. 25 is a sectional view of the dropper seatpost of a seventh embodiment of the present invention.

FIG. 26 is a sectional view of the dropper seatpost of an eighth embodiment of the present invention.

FIG. 27 is a sectional view of the dropper seatpost of a ninth embodiment of the present invention.

FIG. 28 is similar to FIG. 23, showing the valve stem is located at the open position.

FIG. 29 is a sectional view of the pneumatic and hydraulic cylinder provided by the dropper seatpost of a tenth embodiment of the present invention, showing that the valve stem is located at the close position.

FIG. 30 is similar to FIG. 29, showing that the valve stem is located at the close position.

### DETAILED DESCRIPTION OF THE INVENTION

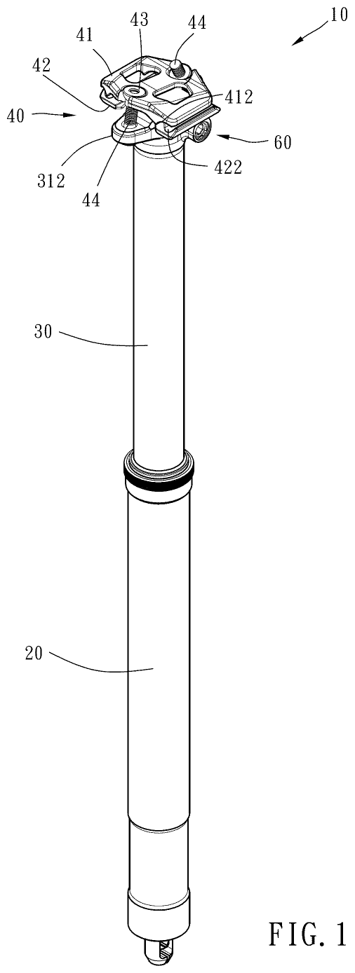

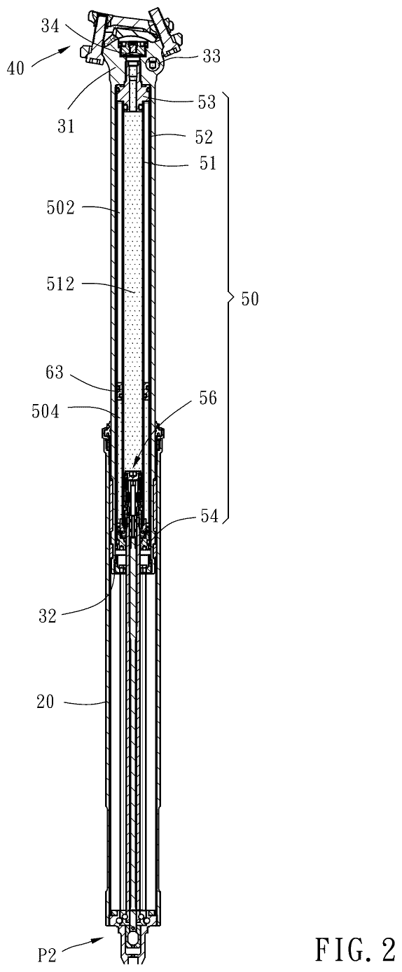

Referring to FIGS. 1 and 2, a dropper seatpost 10 of the first embodiment of the present invention comprises an outer tube 20, an inner tube 30, a saddle clamping device 40, a pneumatic and hydraulic cylinder 50, and a stroke adjustment assembly 60.

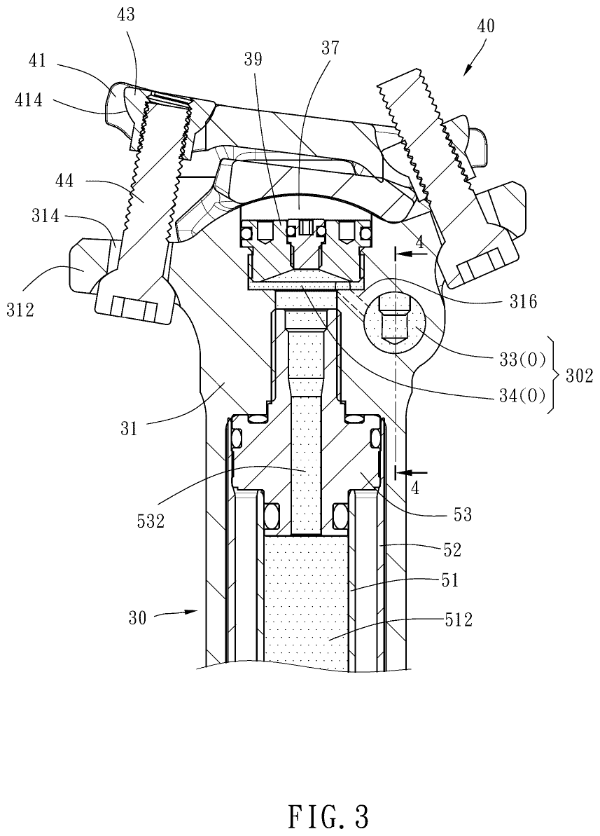

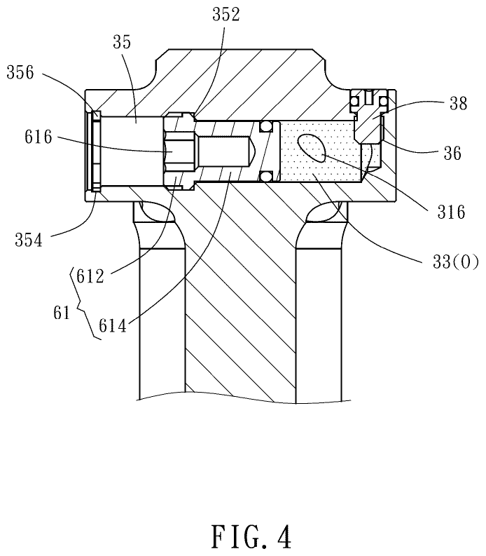

The inner tube 30 is inserted into the outer tube 20 from the top end of the outer tube 20. The inner tube 30 includes a top end 31 located outside the outer tube 20 and a bottom end 32 located inside the outer tube 20. The top end 31 of the inner tube 30 has two ear portions 312 each provided with a counterbored hole 314 (as shown in FIG. 3). Additionally, in this embodiment, the top end 31 of the inner tube 30 has a first oil chamber 33 and a second oil chamber 34. The first and second oil chambers 33, 34 together form an adjustment oil chamber 302, and the first and second oil chambers 33, 34 are used for storage of an oil O. The first oil chamber 33 extends along a radial direction of the inner tube 30, and the second oil chamber 34 extends along an axial direction of the inner tube 30 and communicates with the first oil chamber 33 through a passage 316. As shown in FIGS. 3 and 4, the top end 31 of the inner tube 30 further has an adjustment threaded hole 35, an oil filling hole 36, and an oil replenishing hole 37. The adjustment threaded hole 35 axially communicates with one end of the first oil chamber 33 and forms an inner stop portion 352 with the first oil chamber 33. An outer annular groove 354 is formed on a periphery wall of the adjustment threaded hole 35 for engagement of an outer stop ring 356. The oil filling hole 36 vertically communicates with the opposite end of the first oil chamber 33 and is closed by a screw 38. The oil replenishing hole 37 is provided at the top surface of the inner tube 30 and axially communicates with the second oil chamber 34. The oil replenishing hole 37 is covered by a plunger 39.

The saddle clamping device 40 includes an upper clamping seat 41, a lower clamping seat 42, two nuts 43, and two bolts 44. As shown in FIGS. 1 and 3, two lateral sides of the upper clamping seat 41 each have an upper groove 412, and the other two lateral sides of the upper clamping seat 41 each have a nut hole 414. Two lateral sides of the lower clamping seat 42 each have a lower groove 422 corresponding to the upper clamping groove 412. The nuts 43 are disposed in the nut holes 414 of the upper clamping seat 41. The bolts 44 pass through the counterbored holes 314 from bottom to top and are screwed to the nuts 43. As such, after the assembly of the saddle clamping device 40 is completed, the oil replenishing hole 37 is covered. Additionally, the upper clamping grooves 412 and the lower clamping grooves 422 clamp two saddle bows (not shown) of a saddle (not shown), thereby completing the assembly with the saddle.

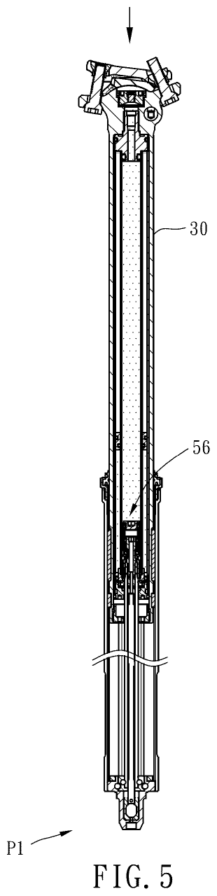

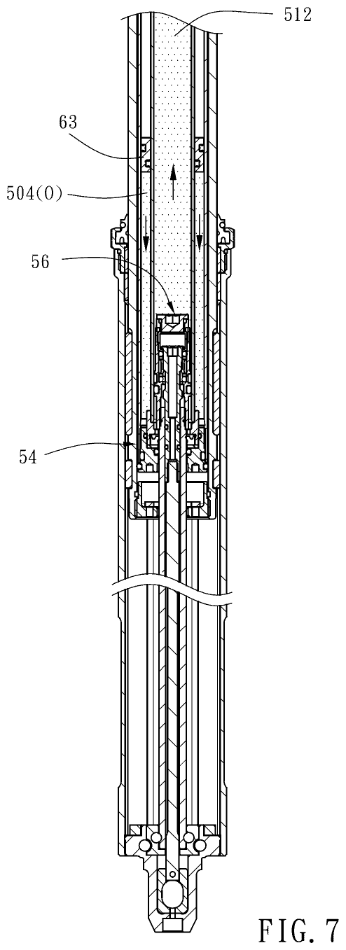

The pneumatic and hydraulic cylinder 50 is a dual-tube structure, including an inner cylinder body 51, an outer cylinder body 52, a top cover 53, a bottom cover 54, and a control valve 56. As shown in FIG. 2, the inner cylinder body 51 has an upper oil chamber 512, and the inner cylinder body 51 is disposed in the outer cylinder body 52 and spaced from the outer cylinder body 52. The top cover 53 is mounted on the top ends of the inner and outer cylinder bodies 51, 52 and forms an air chamber 502 with the inner and outer cylinder bodies 51, 52. The top cover 53 has an upper guide hole 532 axially communicating with the second oil chamber 34 and the upper oil chamber 512. The bottom cover 54 is mounted on the bottom ends of the inner and outer cylinder bodies 51, 52 and forms an outer chamber 504 located below the air chamber 502 with the inner and outer cylinder bodies 51, 52. As shown in FIGS. 5 and 7, the control valve 56 is mounted to the bottom cover 54 and located inside the inner cylinder body 51 for controlling communication between the inner oil chamber 512 and the lower oil chamber 504. For further detailed structure and operation of the control valve 56, please refer to TW M641278. In simple terms, when the control valve 56 is located at an open position P1 (as shown in FIG. 5), the upper and lower oil chambers 512, 504 communicate with each other. At this point, the inner tube 30 is allowed to be moved upward and downward relative to the outer tube 20. When the control valve 56 is located at a close position P2 (as shown in FIG. 2), the upper and lower oil chambers 512, 504 do not communicate with each other. At this point, the inner tube 30 is unable to be moved upward and downward relative to the outer tube 20.

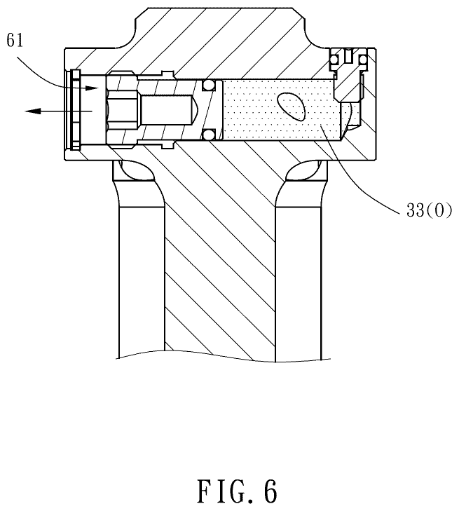

The stroke adjustment assembly 60 includes a knob 61. As shown in FIG. 4, the knob 61 has a threaded head portion 612 screwed to the adjustment threaded hole 35 of the inner tube 30, and a body portion 614 connected with the threaded head portion 612 and inserted into the first oil chamber 33. Additionally, the knob 61 further has a hexagonal hole 616 recessed from the threaded head portion 612 toward the body portion 614 for engagement of a tool (such as a hex wrench, not shown). This ensures that when the knob 61 is driven by the aforementioned tool, it can be rotated and moved inward to rest against the inner stop portion 352 or outward to rest against the outer stop ring 356. When the knob 61 is moved inward to rest against the inner stop portion 352, as shown in FIG. 4, the knob 61 compresses the space in the first oil chamber 33, causing the oil O in the first oil chamber 33 to be pushed through the passage 316 into the second oil chamber 34. When the knob 61 is moved outward, as shown in FIG. 6, the knob 61 releases the space in the first oil chamber 33, allowing the oil O in the second oil chamber 34 to flow through the passage 316 into the first oil chamber 33. As shown in FIG. 2, the stroke adjustment assembly 60 further includes a floating piston 63 movably disposed between the air chamber 502 and the lower oil chamber 504.

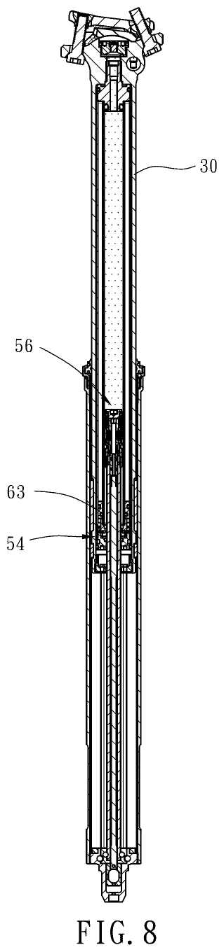

It can be seen from the above that when reducing a maximum upward stroke of the inner tube 30, first open the control valve 56 (as shown in FIG. 5) and press down the inner tube 30 to exceed its adjustable stroke, then rotate the knob 61 outward (as shown in FIG. 6), allowing the oil O to flow from the lower oil chamber 504 through the control valve 56 into the upper chamber 512 (as shown in FIG. 7). Next, as shown in FIG. 3, the oil O flows from the upper oil chamber 512 through the upper guide hole 532 into the second oil chamber 34, and then flows from the second oil chamber 34 into the first oil chamber 33. As such, as shown in FIG. 7, the floating piston 63 is moved downward toward the bottom cover 54 due to the decrease in the oil volume of the lower oil chamber 504. Then, close the control valve 56 and releases the inner tube 30. At this point, as shown in FIG. 8, the inner tube 30 will automatically rise until the bottom cover 54 comes into contact with the floating piston 63, at which point the upward movement will stop. In this way, as shown in FIG. 8, the inner tube 30 is restricted by the floating piston 63 to complete the reduction of the maximum upward stroke.

After complete the reduction of the maximum upward stroke of the inner tube 30, if a rider lowers the height of the inner tube 30 to the minimum by using the control valve 56 after the ride, the next time the rider rides, simply opening the control valve 56 will cause the maximum upward stroke of the inner tube 30 to be limited by the floating piston 63, allowing the inner tube 30 to only rise to the height shown in FIG. 8. For the same rider, there will be no need to readjust the seat height, thus effectively saving operational time and increasing user convenience.

Conversely, to restore the original upward stroke, first open the control valve 56 and press down the inner tube 30 to exceed its adjustable stroke, then rotate the knob 61 inward until it contacts the inner stop portion 352 (as shown in FIG. 4), causing the oil O to flow from the first oil chamber 33 to the second oil chamber 34. Next, the oil O flows from the upper guide hole 532 to the upper oil chamber 512 and then enters the lower oil chamber 504 through the control valve 556. This causes the floating piston 63 to be pushed upward by the oil O entering the lower oil chamber 504 and moved away from the bottom cover 54. Finally, close the control valve 56 and release the inner tube 30. At this point, the inner tube 30 will automatically rise. This completes the restoration of the original upward stroke of the inner tube 30.

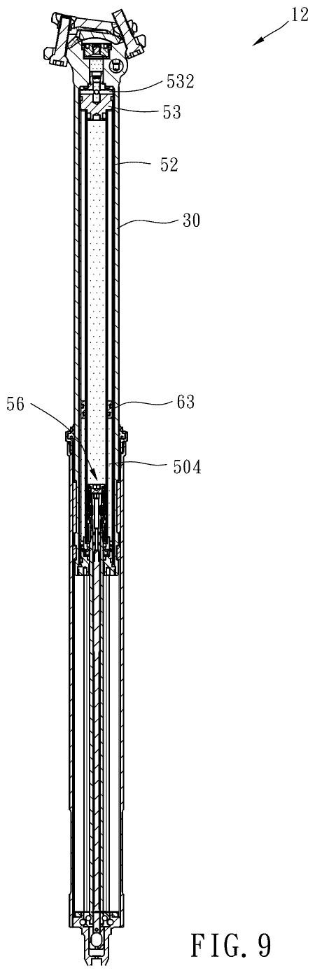

Please refer to FIG. 9, the main structure of the dropper seatpost 12 of a second embodiment is approximately the same with the first embodiment, but one of the differences therebetween is that the return route of the oil O is different.

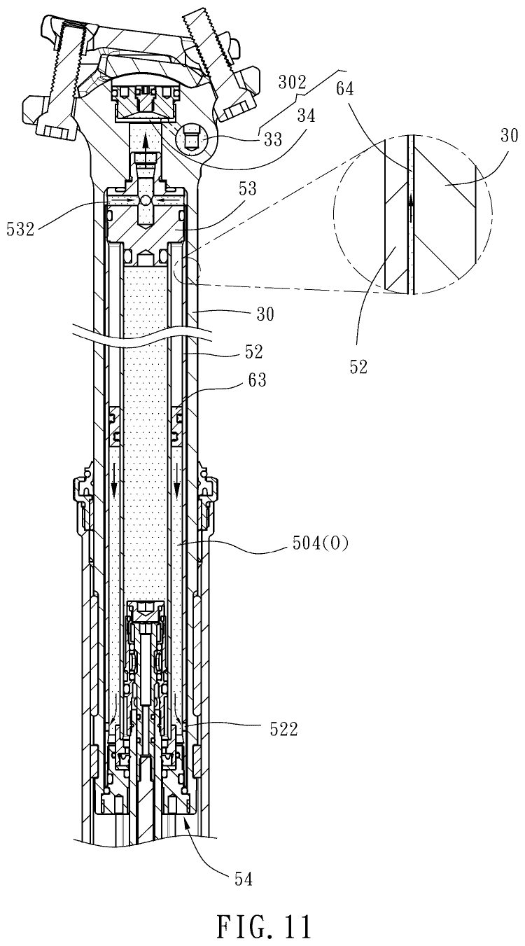

In this embodiment, as shown in FIG. 11, an oil guide channel 64 is formed between the outer surface of the outer cylinder body 52 and the inner surface of the inner tube 30. The oil guide channel 64, the first oil channel 33, and the second oil channel 34 together form the adjustment oil chamber 302. The top cover 53 has a plurality of upper guide holes 532 communicating with the second oil chamber 34 and the oil guide channel 64. The bottom end of the outer cylinder body 52 has a plurality of lower guide holes 522 communicating with the lower oil chamber 504 and the oil guide channel 64.

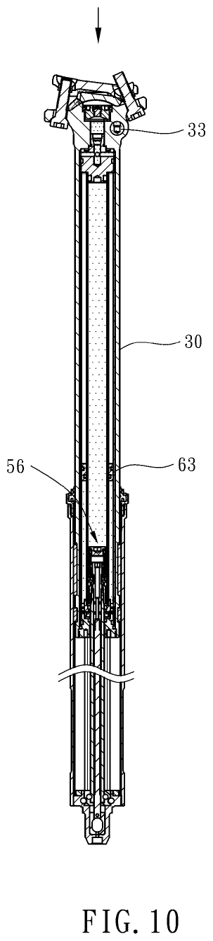

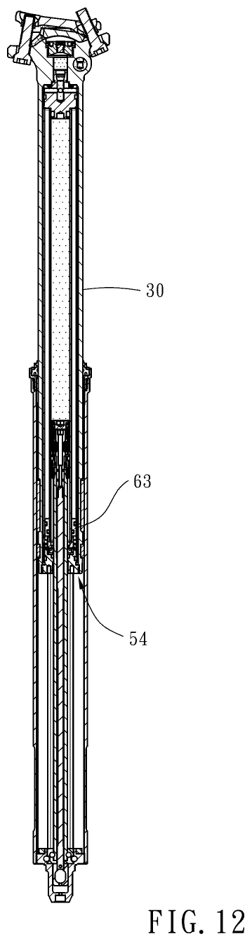

When reducing the maximum upward stroke of the inner tube 70, as shown in FIGS. 10 and 11, first open the control valve 56 and press down the inner tube 30 to exceed its adjustable stroke, then close the control valve 56, temporarily positioning the inner tube 30. Next, rotate the knob 61 outward to release the space in the first oil chamber 33 (as show in FIG. 6). At this point, the oil O flows from the lower oil chamber 504 through the lower guide holes 522, the oil guide channel 64, and the upper guide holes 532 into the second oil chamber 34, and then flows from the second oil chamber 34 into the first oil chamber 33. As such, the floating piston 63 is moved downward toward the bottom cover 54 due to the decrease in the oil volume of the lower oil chamber 504. Then, reopen the control valve 56 and releases the inner tube 30. At this point, the inner tube 30 will automatically rise until the bottom cover 54 comes into contact with the floating piston 63, at which point the upward movement will stop. In this way, as shown in FIG. 12, the inner tube 30 is restricted by the floating piston 63 to complete the reduction of the maximum upward stroke.

Conversely, to restore the original upward stroke, first open the control valve 56 and press down the inner tube 30 to exceed its adjustable stroke, then close the control valve 56, temporarily positioning the inner tube 30. Next, rotate the knob 61 inward until it contacts the inner stop portion 352 (as shown in FIG. 4), causing the oil O to flow from the first oil chamber 33 to the second oil chamber 34. Then, the oil O flows from the second oil chamber 34 through the upper guide holes 532, the oil channel 64, and the lower guide holes 522 into the lower oil chamber 504. This causes the floating piston 63 to be pushed upward by the oil O entering the lower oil chamber 504 and moved away from the bottom cover 54. Finally, reopen the control valve 56 and release the inner tube 30. At this point, the inner tube 30 will automatically rise. This completes the restoration of the original upward stroke of the inner tube 30.

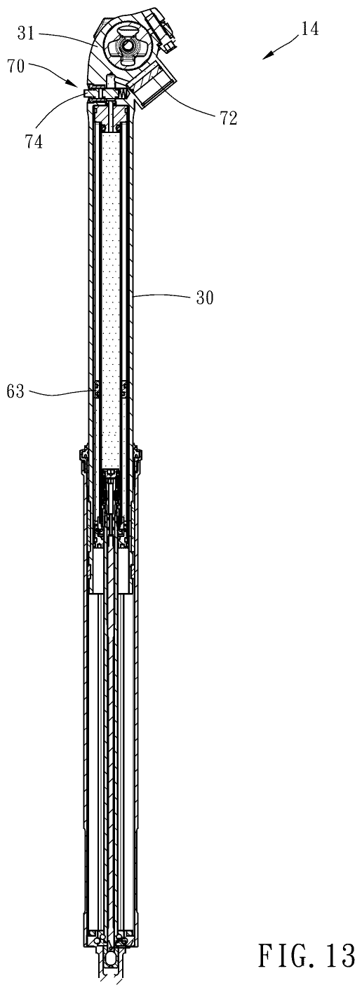

Please refer to FIG. 13, the main structure of the dropper seatpost 14 of a third embodiment is approximately the same with the first embodiment, but one of the differences therebetween is that the stroke adjustment assembly 70 uses a piston 72 to replace the knob 61, and uses a button 74 to control the oil O.

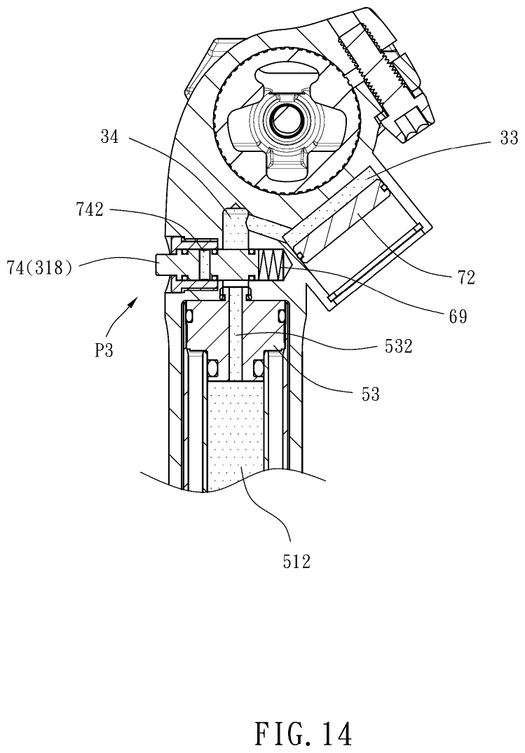

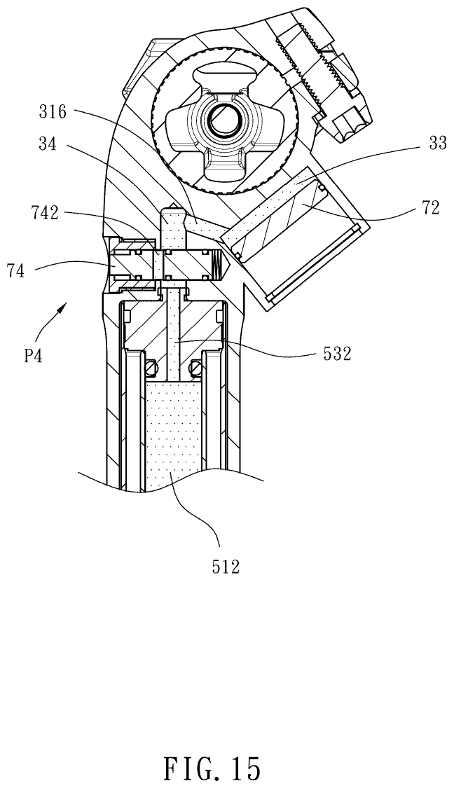

In this embodiment, as shown in FIG. 14, the top end 31 of the inner tube 30 further includes a button hole 318 radially communicating with the second oil chamber 34 and the upper guide hole 532. When the button 74 is located an initial position P3 as shown in FIG. 14 under an elastic force generated by a return elastic member 69, the second oil chamber 34 and the upper guide hole 532 are blocked by the button 74, so that they do not communicate with each other. When the button 74 is located at a pressed position P4 as shown in FIG. 15, the second oil chamber 34 and the upper guide hole 532 communicate with each other through a communicate hole 742 of the button 74.

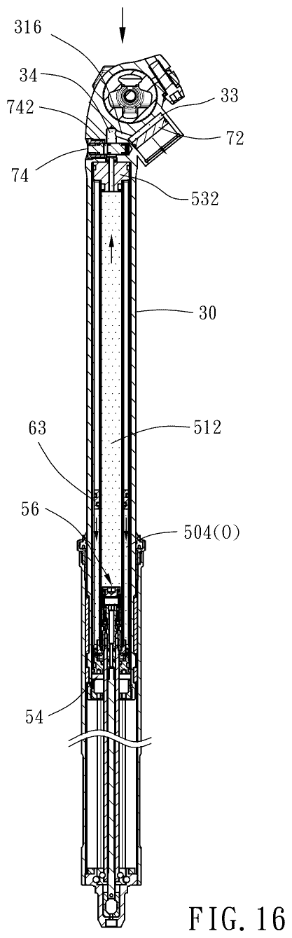

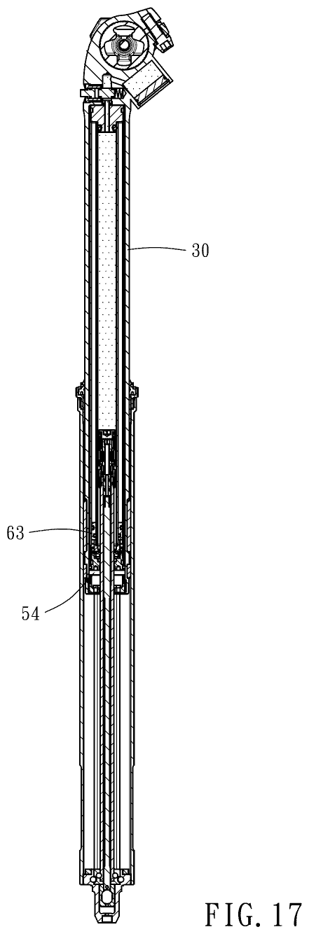

When reducing the maximum upward stroke of the inner tube 30, as shown in FIG. 16, first open the control valve 56 and press down the inner tube 30 to exceed its adjustable stroke, then press the button 74 to the pressed position P4 as shown in FIG. 15, causing the oil O in the lower oil chamber 504 to flow through the control valve 56 into the upper oil chamber 512. Then, the oil O flows from the upper oil chamber 512 through the upper guide hole 532 and the communicate hole 742 into the second oil chamber 34. Next, the oil O flows from the second oil chamber 34 through the passage 316 into the first oil chamber 33 and pushes the piston 72 outward. As such, the floating piston 63 is moved downward toward the bottom cover 54 due to the decrease in the oil volume of the lower oil chamber 504. Then, release the button 74 and close the control valve and release the inner tube 30. At this point, the inner tube 30 will automatically rise until the bottom cover 54 comes into contact with the floating piston 63, at which point the upward movement will stop. In this way, as shown in FIG. 17, the inner tube 30 is restricted by the floating piston 63 to complete the reduction of the maximum upward stroke.

Conversely, to restore the original upward stroke, first open the control valve 56 and press down the inner tube 30 to exceed its adjustable stroke, then press the button 74 and push the piston 72 inward to the bottom, causing the oil O to flow from the first oil chamber 33 through the passage 316 to the second oil chamber 34. Next, the oil O flows from the second oil chamber 34 through the upper guide hole 532 and the communicate hole 742 into the upper oil chamber 512. The oil O then flows from the upper oil chamber 512 through the control valve 56 into the lower oil chamber 504. This causes the floating piston 63 to be pushed upward by the oil O entering the lower oil chamber 504 and moved away from the bottom cover 54. Finally, close the control valve 56 and reopen the inner tube 30. At this point, the inner tube 30 will automatically rise. This completes the restoration of the original upward stroke of the inner tube 30.

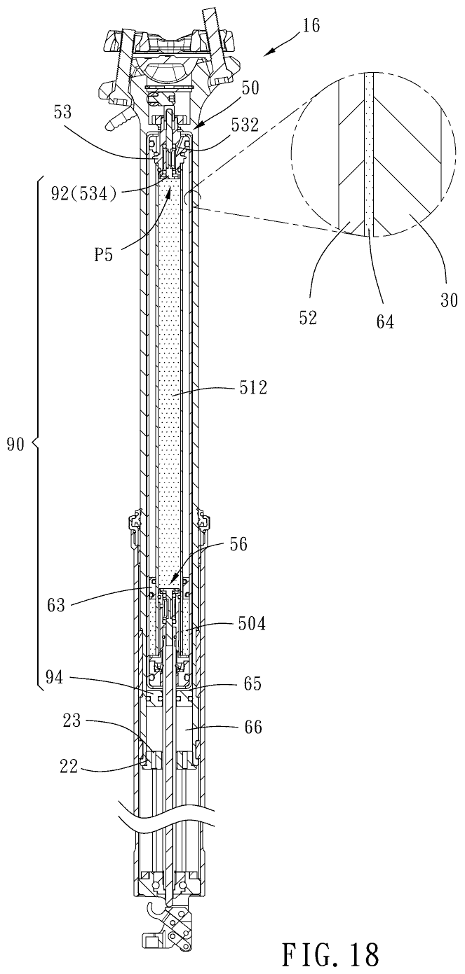

Please refer to FIG. 18, the main structure of the dropper seatpost 16 of a fourth embodiment is approximately the same with the second embodiment, but one of the differences therebetween is that the stroke adjustment assembly 90 uses a plunger 92 to control the oil O.

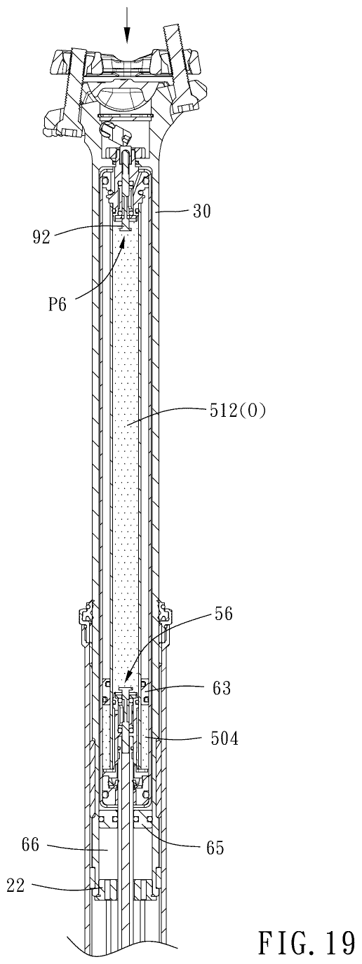

In this embodiment, an oil guide channel 64 is formed between the outer surface of the outer cylinder body 52 and the inner surface of the inner tube 30, and the bottom end 32 of the inner tube 30 is equipped with an end cover 22 located below the pneumatic and hydraulic cylinder 50. Additionally, the top cover 53 has an upper guide hole 532 communicating with the oil guide channel 64 and a plunger hole 534 communicating with the upper guide hole 532 and the upper oil chamber 512. As shown in FIG. 18, the stroke adjustment assembly 90 includes a plunger 90 disposed in the plunger hole 534 and operatable between a close position P5 and an open position P6. When the plunger 90 is located at the close position P5 as shown in FIG. 18, the upper oil chamber 512 and the upper guide hole 532 are blocked by the plunger 90, so that they are not interconnected. When the plunger 90 is located at the open position P6 as shown in FIG. 19, the upper oil chamber 512 and the upper guide hole 532 are interconnected through the plunger hole 534. The stroke adjustment assembly 90 further includes an adjustment piston 94 movably disposed between the bottom cover 54 and the end cover 22. On the one hand, the adjustment piston 94 forms an oil storage space 65 between itself and the bottom cover 54. The oil storage space 65 and the oil guide channel 64 together form the adjustment oil chamber 302. On the other hand, the adjustment piston 94 forms an air chamber 66 between itself and the end cover 22. The air chamber 66 is connected to the outside through multiple exhaust holes 23 of the end cover 22.

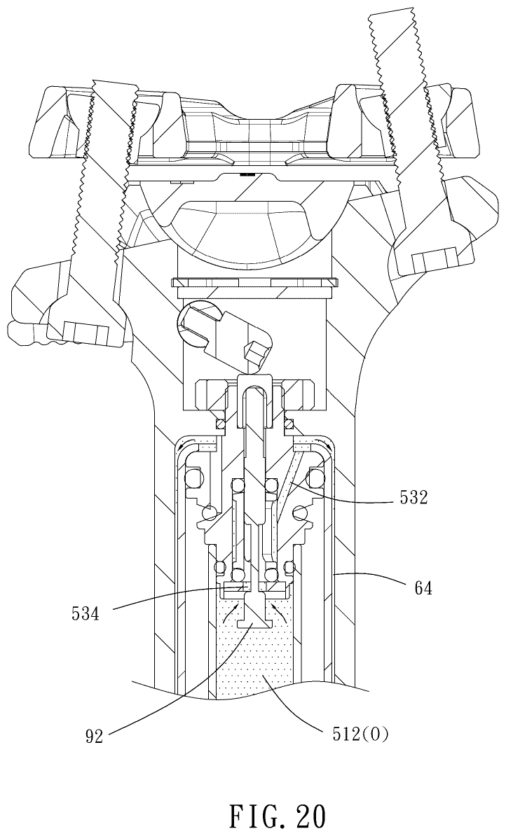

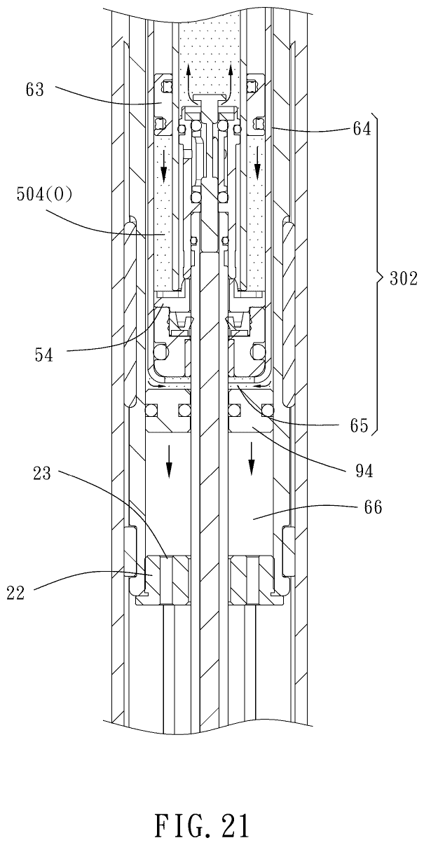

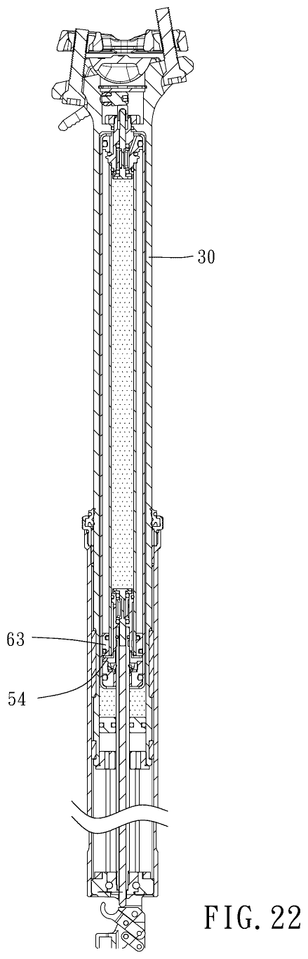

When reducing the maximum upward stroke of the inner tube 30, first open the control valve 56 and the plunger 92 and press down the inner tube 30 to exceed its adjustable stroke, as shown in FIGS. 19-21. At this point, the floating piston 63 is pushed by the air pressure and moved toward the bottom cover 54. Meanwhile, the oil O flows from the lower oil chamber 504 into the upper oil chamber 512 through the control valve 56. The oil O then flows from the upper oil chamber 512 through the plunger hole 534 and the upper oil hole 532 into the oil guide channel 64, and finally travels along the oil guide channel 64 into the oil storage space 65. This increases the oil volume in the oil storage space 65. As such, the adjustment piston 94 is moved toward the end cover 22 due to the increase in the oil volume in the oil storage space 65, causing the air in the air chamber 66 to be exhausted to the outside through the exhaust holes 23. Then, close the control valve 56 and the plunger 92 and release the inner tube 30. At this point, the inner tube 30 will automatically rise until the bottom cover 54 comes into contact with the floating piston 63, at which point the upward movement will stop. In this way, as shown in FIG. 22, the inner tube 30 is restricted by the floating piston 63 to complete the reduction of the maximum upward stroke.

Conversely, to restore the original upward stroke, first open the control valve 56 and the plunger 92 and press down the inner tube 30 to exceed its adjustable stroke. At this time, the oil O flows from the oil storage space 65 through the oil guide channel 64, the upper guide hole 532, and the plunger hole 534 into the upper oil chamber 512. Then, the oil O flows from the upper oil chamber 512 through the control valve 56 into the lower oil chamber 504, causing the floating piston 63 to be pushed by the oil O entering the lower oil chamber 504 and moved away from the bottom cover 54. Finally, close the control valve 56 and the plunger 92 and release the inner tube 30. At this point, the inner tube 30 will automatically rise. This completes the restoration of the original upward stroke of the inner tube 30.

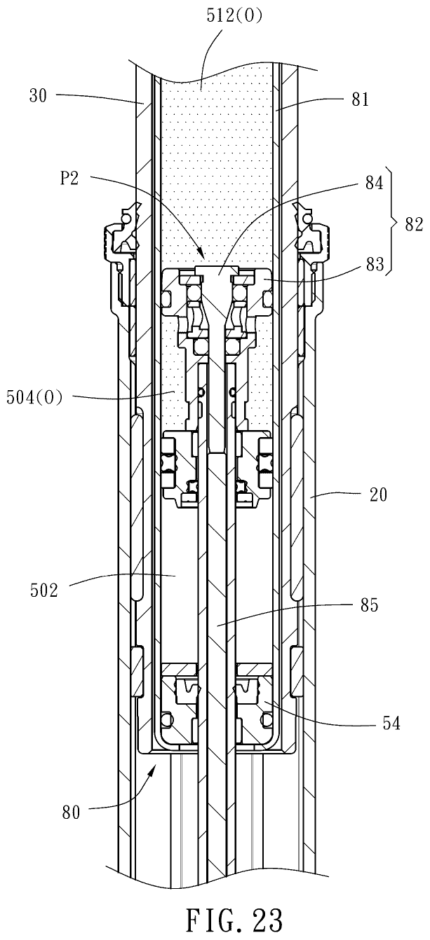

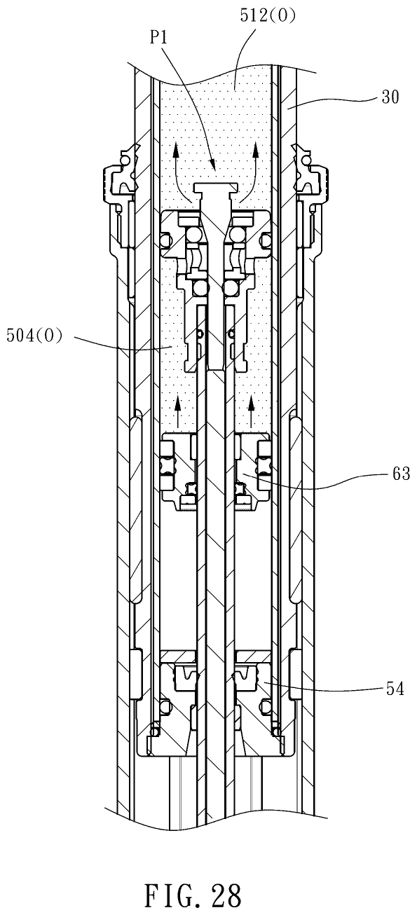

It should be supplemented here that the pneumatic and hydraulic cylinders 50 used in the aforesaid embodiments are all dual-tube structures. However, in fact, the pneumatic and hydraulic cylinders 80 of a single-tube structure can also be used. As shown in FIG. 23, the pneumatic and hydraulic cylinders 80 includes a cylinder body 81 provide with an upper oil chamber 512, a lower oil chamber 504, and an air chamber 502. The control valve 82 has a valve seat 83 and a valve stem 84. The valve seat 83 is mounted in the cylinder body 81 to separate the upper oil chamber 512 and the lower oil chamber 504. The valve stem 84 is disposed in the valve seat 83 and driven by a rod 85 to operate between an open position P1 and a close position P2. When the valve stem 84 is located at the open position P1 as shown in FIG. 28, the upper oil chamber 512 and the lower oil chamber 504 communicate with each other, so that the inner tube 30 is allowed to be moved relative to the outer tube 20. When the valve stem 84 is located at the close position P2 as shown in FIG. 23, the upper oil chamber 512 and the lower oil chamber 504 do not communicate with each other, so that the inner tube 30 is unable to be moved relative to the outer tube 20.

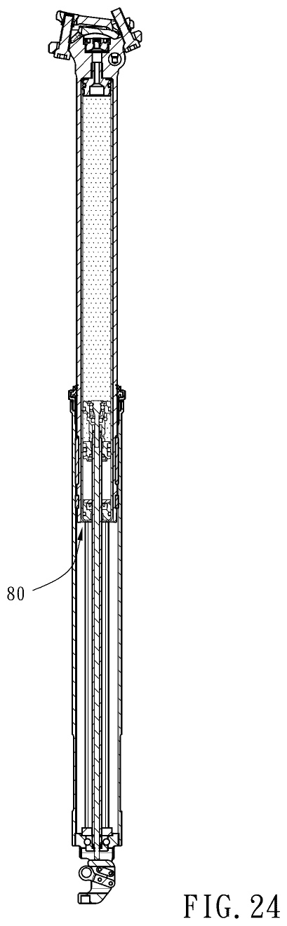

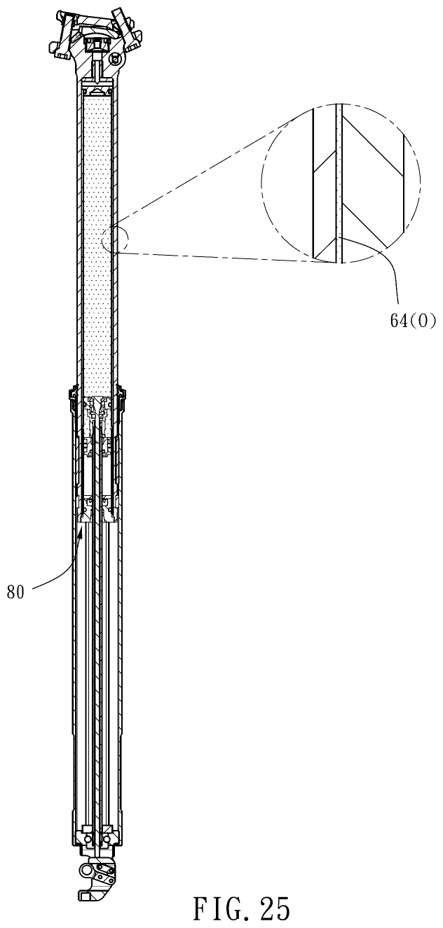

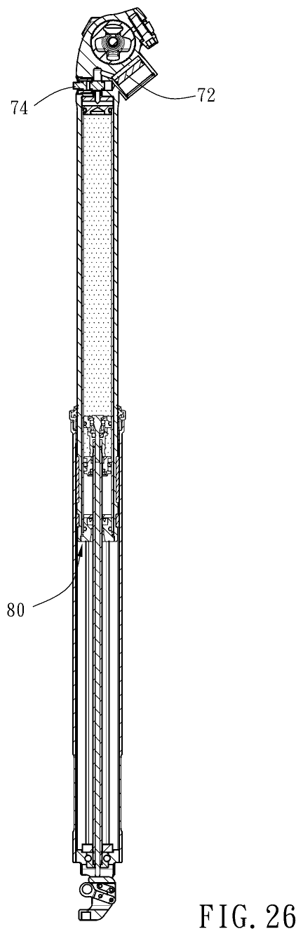

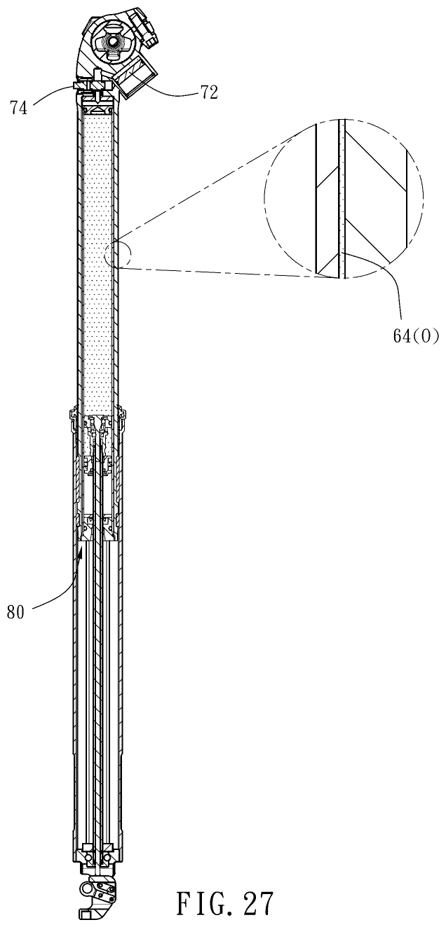

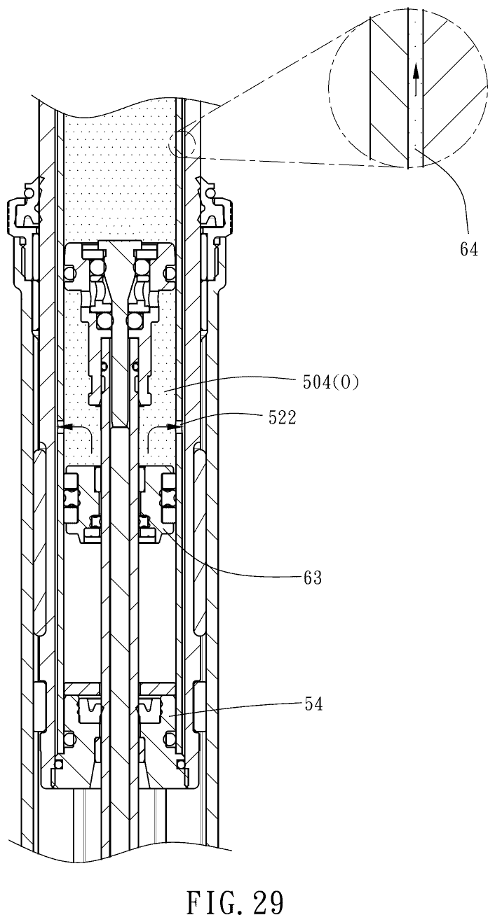

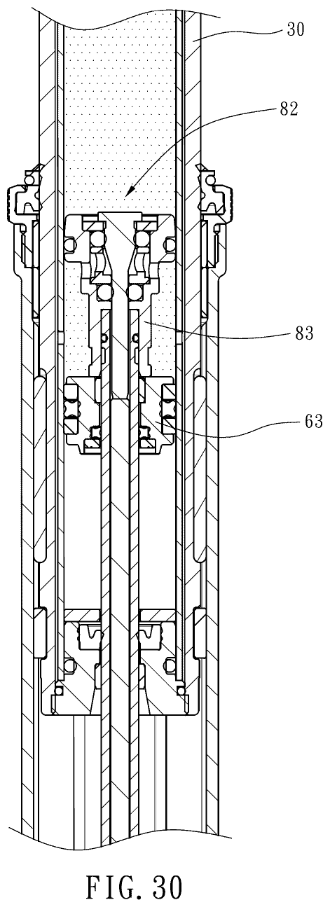

In actual use, the pneumatic and hydraulic cylinder 80 can be used in conjunction with the knob 61 provided by the first embodiment of the present invention (as shown in FIG. 24), or with the oil guiding channel 64 provided by the second embodiment of the present invention (as shown in FIG. 25), or with the piston 72 and button 74 provided by the third embodiment of the present invention (as shown in FIG. 26), or simultaneously with both the oil guiding channel 64 provided by the second embodiment and the piston 72 and button 74 provided by the third embodiment (as shown in FIG. 27). However, regardless of which of the above embodiments is used, the method for adjusting the maximum upward stroke of the inner tube 30 is the same as in the aforementioned embodiments. In simple terms, when the oil O in the lower oil chamber 504 is extracted from the upper oil chamber 512 (as shown in FIG. 28), or the oil O is injected from the upper oil chamber 512 into the lower oil chamber 504, or the oil O in the lower oil chamber 504 is extracted from the oil guide channel 64 through the lower guide hole 522 (as shown in FIG. 29), or the oil O is injected from the oil guide channel 64 into the lower oil chamber 504 through the lower guide hole 522, the floating piston 63 is moved closer to or farther from the bottom cover 54 based on the change in the oil volume in the lower oil chamber 504. Then, close the control valve 82 and release the inner tube 30. At this point, the inner tube 30 will automatically rise until the floating piston 63 comes into contact with the valve seat 83, at which point the upward movement will stop (as shown in FIGS. 23 and 30). In this way, the inner tube 30 is restricted by the floating piston 63 to complete the reduction of the maximum upward stroke.

As indicated above, the dropper seatpost 10, 12, 14, 16 of the present invention utilizes the stroke adjustment assembly 60, 70 in conjunction with the oil O to adjust the maximum upward stroke of the inner tube 30. Once the adjustment is completed, there is no need to readjust the saddle height for the same rider, thus effectively saving operation time and enhancing user convenience.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dropper seatpost comprising:
an outer tube;
an inner tube disposed movably upward and downward in the outer tube, the inner tube having a top end located outside the outer tube and a bottom end located inside the outer tube;
a pneumatic and hydraulic cylinder disposed in the inner and outer tubes for controlling a vertical movement of the inner tube relative to the outer tube and having at least one cylinder body provided with an upper oil chamber, a lower oil chamber,, and an air chamber, a top cover mounted to a top end of the cylinder body, a bottom cover mounted to a bottom end of the cylinder body, and a control valve disposed in the cylinder body to separate the upper and lower oil chambers and operatable between an open position where the upper and lower oil chambers communicate with each other and a close position where the upper and lower oil chambers do not communicate with each other; and
a stroke adjustment assembly including a floating piston movably disposed between the air chamber and the lower oil chamber and moved toward the bottom cover or away from the bottom cover when an oil is extracted from or injected into the upper oil chamber, or the oil is extracted from or injected into the lower oil chamber, thereby adjusting a maximum upward stroke of the inner tube;
wherein when the oil is extracted from the upper oil chamber, the oil flows from the lower oil chamber through the upper oil chamber into an adjustment oil chamber, allowing the floating cover to be moved toward the bottom cover, and when the oil is injected into the upper oil chamber, the oil flows from the adjustment oil chamber into the lower oil chamber through the upper oil chamber, allowing the floating cover to be moved away from the bottom cover;
wherein when the oil is extracted from the lower oil chamber, the oil flows from the lower oil chamber into the adjustment oil chamber, allowing the floating cover to be moved toward the bottom cover, and when the oil is injected into the lower oil chamber, the oil flows from the adjustment oil chamber into the lower oil chamber, allowing the floating cover to be moved away from the bottom cover.

2. The dropper seatpost as claimed in claim 1, wherein the pneumatic and hydraulic cylinder includes two said cylinder bodies that are an inner cylinder body with the upper oil chamber and an outer cylinder body; the top cover is mounted to top ends of the inner and outer cylinder bodies and forms the air chamber with the inner and outer cylinder bodies; the bottom cover is mounted to bottom ends of the inner and outer cylinder bodies and forms the lower oil chamber with the inner and outer cylinder bodies.

3. The dropper seatpost as claimed in claim 1, wherein the pneumatic and hydraulic cylinder includes one said cylinder body; the upper oil chamber is formed between the top cover and the control valve; the lower oil chamber is formed between the control valve and the floating piston; the air chamber is formed between the floating piston and the bottom cover.

4. The dropper seatpost as claimed in claim 1, wherein the top end of the inner tube has a first oil chamber, a second oil chamber communicating with the first oil chamber and the upper oil chamber, and an adjustment threaded hole communicating with the first oil chamber; the stroke adjustment assembly further includes a knob screwed to the adjustment threaded hole for pushing the oil in the first oil chamber to the second oil chamber or allowing the oil in the second oil chamber to flow back into the first oil chamber; when the oil in the second oil chamber is allowed to flow back into the first oil chamber, and the control valve is located at the open position, the oil in the lower oil chamber flows into the upper oil chamber, allowing the floating piston to be moved toward the bottom cover; the first oil chamber and the second oil chamber together form the adjustment oil chamber.

5. The dropper seatpost as claimed in claim 2, wherein the top end of the inner tube has a first oil chamber, a second oil chamber communicating with the first oil chamber, and an adjustment threaded hole communicating with the first oil chamber; an oil guide channel is formed between the pneumatic and hydraulic cylinder and the inner tube; the top cover has an upper guide hole communicating the second oil chamber and the oil guide channel; the pneumatic and hydraulic cylinder has a lower guide hole communicating the lower oil chamber and the oil guide channel; the stroke adjustment assembly further includes a knob screwed to the adjustment threaded hole for pushing the oil in the first oil chamber to the second oil chamber or allowing the oil in the second oil chamber to flow back into the first oil chamber; when the oil in the second oil chamber is allowed to flow back into the first oil chamber, the oil in the lower oil chamber flows through the lower guide hole, the oil guide channel, and the upper guide hole into the second oil chamber, allowing the floating piston to be moved toward the bottom cover; the first oil chamber and the second oil chamber together form the adjustment oil chamber.

6. The dropper seatpost as claimed in claim 1, wherein the top end of the inner tube has a first oil chamber, a second oil chamber communicating with the first oil chamber, and a button hole communicating with the second oil chamber and the upper oil chamber; the stroke adjustment assembly further includes a piston movably disposed in the first oil chamber for pushing the oil in the first oil chamber into the second oil chamber or allowing the oil in the second oil chamber to flow back into the first oil chamber, a button movably disposed in the button hole and movable between an initial position where the second oil chamber and the upper oil chamber do not communicate with each other by obstruction of the button and a pressed position where the second oil chamber and the upper oil chamber communicate with each other through a communication hole of the button, and a return elastic member acting on the button to keep the button in the initial position; when the oil in the upper oil chamber is extracted while the button is in the pressed position and the control valve is in the open position, the oil in the lower oil chamber flows into the upper oil chamber, allowing the floating piston to be moved toward the bottom cover; the first oil chamber and the second oil chamber together form the adjustment oil chamber.

7. The dropper seatpost as claimed in claim 1, wherein the top end of the inner tube has a first oil chamber, a second oil chamber communicating with the first oil chamber and the upper oil chamber, and an adjustment threaded hole communicating with the first oil chamber; the stroke adjustment assembly further includes a knob screwed to the adjustment threaded hole for pushing the oil in the first oil chamber to the second oil chamber or allowing the oil in the second oil chamber to flow back into the first oil chamber; when knob pushes the oil in the first oil chamber to the second oil chamber, and the control valve is in the open position, the oil in the upper oil chamber flows into the lower oil chamber, allowing the floating piston to be moved away from the bottom cover; the first oil chamber and the second oil chamber together form the adjustment oil chamber.

8. The dropper seatpost as claimed in claim 1, wherein the top end of the inner tube has a first oil chamber, a second oil chamber communicating with the first oil chamber, and an adjustment threaded hole communicating with the first oil chamber; an oil guide channel is formed between an outer surface of the pneumatic and hydraulic cylinder and an inner surface of the inner tube; the top cover has an upper guide hole communicating the second oil chamber and the oil guide channel; the pneumatic and hydraulic cylinder has a lower guide hole communicating the lower oil chamber and the oil guide channel; the stroke adjustment assembly further includes a knob screwed to the adjustment threaded hole for pushing the oil in the first oil chamber to the second oil chamber or allowing the oil in the second oil chamber to flow back into the first oil chamber; when the knob pushes the oil in the first oil chamber to the second oil chamber, the oil flows from the second oil chamber into the lower oil chamber through the upper guide hole, the oil guide channel, and the lower guide hole, allowing the floating piston is moved away from the bottom cover; the oil guide channel, the first oil chamber, and the second oil chamber together form the adjustment oil chamber.

9. The dropper seatpost as claimed in claim 1, wherein the top end of the inner tube has a first oil chamber, a second oil chamber communicating with the first oil chamber, and a button hole communicating with the second oil chamber and the upper oil chamber; the stroke adjustment assembly further includes a piston movably disposed in the first oil chamber for pushing the oil in the first oil chamber into the second oil chamber or allowing the oil in the second oil chamber to flow back into the first oil chamber, a button movably disposed in the button hole and movable between an initial position where the second oil chamber and the upper oil chamber do not communicate with each other by obstruction of the button and a pressed position where the second oil chamber and the upper oil chamber communicate with each other through a communication hole of the button, and a return elastic member acting on the button to keep the button in the initial position; when the oil is injected into the upper oil chamber while the button is in the pressed position and the control valve is in the open position, the oil flows from the upper oil chamber into the lower oil chamber, allowing the floating piston to be moved away from the bottom cover; the first oil chamber and the second oil chamber together form the adjustment oil chamber.

10. The dropper seatpost as claimed in claim 1, wherein an oil guide channel is formed between an outer surface of the pneumatic and hydraulic cylinder and an inner surface of the inner tube, and an oil storage space communicating with the oil guide channel is formed between a bottom end of the pneumatic and hydraulic cylinder and the bottom end of the inner tube; the top cover has an upper guide hole communicating with the oil guide channel and a plunger hole communicating with the upper guide hole and the upper oil chamber; the stroke adjustment assembly further includes a plunger disposed in the plunger hole and operable between a close position where the upper oil chamber and the upper guide hole do not communicate with each other and an open position where the upper oil chamber and the upper guide hole communicate with each other; the oil guide channel and the oil storage space together form the adjustment oil chamber.

11. The dropper seatpost as claimed in claim 10, wherein the bottom end of the inner tube is equipped with an end cover; the stroke adjustment assembly further includes an adjustment piston movably disposed between the bottom cover and the end cover; the oil storage space is formed between the adjustment piston and the bottom cover, and e air chamber is formed between the adjustment piston and the end cover; when the oil is extracted from the upper oil chamber, the adjustment piston is moved toward the end cover, and when the oil is injected into the upper oil chamber, the adjustment piston is moved away from the end cover.
